(19) United States
(12) Patent Application Publication
(10) Pub. No.: US 2023/0206635 A1
(43) Pub. Date: Jun. 29, 2023

(54) INFORMATION PROCESSING DEVICE, CONTROL METHOD, AND RECORDING MEDIUM

(71) Applicant: NEC Corporation, Minato-ku, Tokyo (JP)

(72) Inventors: Yu Nabeto, Tokyo (JP); Katsumi Kikuchi, Tokyo (JP); Soma Shiraishi, Tokyo (JP); Haruna Watanabe, Tokyo (JP)

(73) Assignee: NEC Corporation, Minato-ku, Tokyo (JP)

(21) Appl. No.: 17/926,903

(22) PCT Filed: May 26, 2020
(86) PCT No.: PCT/JP2020/020775

§ 371 Date: Nov. 21, 2022

(51) Int. Cl. G06V 20/40; G06V 20/70; H04N 23/90

(52) U.S. Cl. CPC G06V 20/46; G06V 20/44; G06V 20/49; G06V 20/70; H04N 23/90

(57) ABSTRACT

The information processing device mainly includes a reference time determination means 16X, a further camera shot extraction means 17X, and a digest candidate generation means 18X. The reference time determination means 16X determines a reference time Tref being a time or a time period for extracting video data of a second camera different from a first camera, based on candidate video data Cd1 to be a candidate of a digest of a first video material data from the first camera. The further shot extraction means 17X extracts a further camera shot Sh corresponding to a portion of a second video material data from the second camera based on the reference time Tref. The digest candidate generation means 18X generates a digest candidate Cd being a digest for the first and second video material data, based on the candidate video data Cd1 and the further camera shot Sh.

### TECHNICAL FIELD

The present disclosure relates to a technology of an information processing device, a control method and a storage medium for performing a process concerning a generation of a digest.

### BACKGROUND ART

There exists a technology which edits video data to be a material and generates a digest. For example, Patent Document 1 discloses a method for producing the digest by confirming a highlight scene from a video stream of a sports event at the ground.

### PRECEDING TECHNICAL REFERENCES

### Patent Document

Patent Document 1: Japanese Laid-open Patent Publication No. 2019-522948

### SUMMARY

### Problem to be Solved by the Invention

In a case of taking sports or the like as subject on video, it is common to carry out taking videos using a plurality of cameras. On the other hand, Patent Document 1 does not disclose any method for generating a digest based on respective sets of video data generated by the plurality of cameras.

It is one object of the present disclosure to provide an information processing device, a control method, and a storage medium, which are capable of preferably generating a digest candidate based on the respective sets of video data of the plurality of cameras, in consideration of the above problems.

### Means for Solving the Problem

According to an example aspect of the present disclosure, there is provided an information processing device including: a reference time determination means configured to determine a reference time that indicates a time or a time period to be a reference for extracting video data of a second camera different from a first camera, based on candidate video data to be a candidate of a digest of first video material data captured by the first camera; a further camera shot extraction means configured to extract a further camera shot to be video data of a portion of second video material data captured by the second camera, based on the reference time; and a digest candidate generation means configured to generate a digest candidate that is a candidate of a digest with respect to the first video material data and the second video material data, based on the candidate video data and the further camera shot.

According to another example aspect of the present disclosure, there is provided a control method performed by a computer, the control method including: determining a reference time that indicates a time or a time period to be a reference for extracting video data of a second camera different from a first camera, based on candidate video data to be a candidate of a digest of first video material data captured by the first camera; extracting a further camera shot to be video data of a portion of second video material data captured by the second camera, based on the reference time; and generating a digest candidate that is a candidate of a digest with respect to the first video material data and the second video material data, based on the candidate video data and the further camera shot.

According to still another example aspect of the present disclosure, there is provided a recording medium storing a program, the program causing a computer to perform a process including: determining a reference time that indicates a time or a time period to be a reference for extracting video data of a second camera different from a first camera, based on candidate video data to be a candidate of a digest of first video material data captured by the first camera; extracting a further camera shot to be video data of a portion of second video material data captured by the second camera, based on the reference time; and generating a digest candidate that is a candidate of a digest with respect to the first video material data and the second video material data, based on the candidate video data and the further camera shot.

### Effect of the Invention

According to the present disclosure, it is possible to preferably generate a candidate of a digest based on respective sets of video data generated by a plurality of cameras.

### BRIEF DESCRIPTION OF THE DRAWINGS

FIG. 1 illustrates a configuration of a digest candidate selection system according to a first example embodiment.

FIG. 2 illustrates a hardware configuration of an information processing device.

FIG. 3 illustrates examples of functional blocks of the information processing device.

FIG. 4A is a diagram representing first video material data by a band graph with a length corresponding to a playback time length of first video material data. FIG. 4B illustrates a line graph indicating a first score in time series of the first video material data. FIG. 4C is a diagram representing second video material data by a band graph with a length corresponding to a playback time length of the second video material data. FIG. 4D illustrates a line graph indicating the first score in time series of the second video material data.

FIG. 5A illustrates a band graph of the first video material data. FIG. 5B illustrate a band graph of the second video material data explicitly representing a further camera shot. FIG. 5C illustrates a band graph of a digest candidate generated based on the first video material data and the second video material data.

FIG. 6A illustrates a band graph of the first video material data. FIG. 6B illustrates a band graph of the second video material data explicitly representing the further camera shot. FIG. 6C illustrates a band graph of a digest candidate to be generated based on the first video material data and the second video material data.

FIG. 7 illustrates a schematic configuration of a learning system that trains a first inference section and a second inference section.

FIG. 8 illustrates an example of a flowchart representing steps of a process executed by the information processing device in the first example embodiment.

FIG. 9 illustrates an example of a flowchart representing steps of a process executed by an information processing device in Modification 1.

FIG. 10A illustrates a band graph of the first video material data. FIG. 10B illustrates a band graph of the second video material data which explicitly representing a further camera shot. FIG. 10C illustrates a band graph of the digest candidate which has been generated.

FIG. 11 illustrates an example of a flowchart representing steps of a process executed by an information processing device in Modification 3.

FIG. 12 is a functional block diagram of an information processing device in a second example embodiment.

FIG. 13 illustrates an example of a flowchart of a process executed by the information processing device second example embodiment.

### EXAMPLE EMBODIMENTS

In the following, example embodiments of an information processing device, a control method, and a recording medium will be described with reference to the accompanying drawings.

### First Example Embodiment

(1) System Configuration

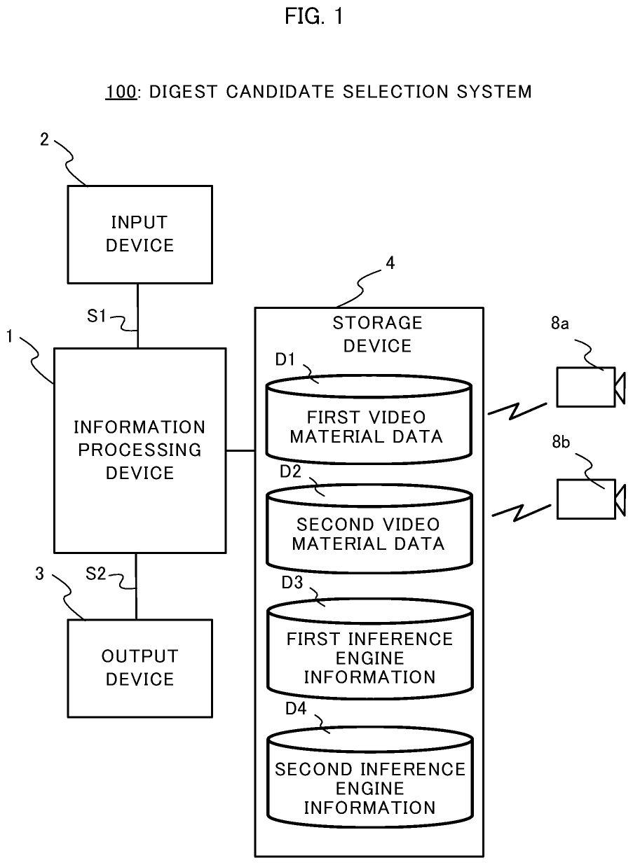

FIG. 1 illustrates a configuration of a digest candidate selection system 100 according to a first example embodiment. The digest candidate selection system 100 preferably selects video data (also referred to as a “digest candidate Cd”) to be a candidate for a digest from sets of video data respectively captured by a plurality of cameras. The digest candidate selection system 100 mainly includes an information processing device 1, an input device 2, an output device 3, a storage device 4, a first camera 8a, and a second camera 8b. Hereafter, the video data may include sound data. Moreover, the video data which to be a material in a case of selecting of the digest candidate Cd is called “video material data”.

The information processing device 1 performs data communications with the input device 2 and the output device 3 through a communication network or by a direct wireless or wired connection. The information processing device 1 generates the digest candidate Cd based on respective sets of video material data captured by the first camera 8a and the second camera 8b.

The first camera 8a and the second camera 8b are, for instance, cameras used in a venue of an event (that is, in a sports field), and capture the event on video from different positions during the same time period. For instance, the first camera 8a is a camera that produces a main video used to generate the digest candidate Cd, and the second camera 8b is a camera that produces a video to be employed as a portion of the digest candidate Cd in a particular important moment. For instance, in taking a video of a ball game, the first camera 8a may be a camera that captures the entire ball field on video, the second camera 8b may be a camera that mainly captures a player near a ball.

The input device 2 is any user interface that receives inputs of a user, and corresponds to, for instance, a button, a keyboard, a mouse, a touch panel, a voice input device, or the like. The input device 2 supplies an input signal “S1” generated based on the inputs of the user to the information processing device 1. The output device 3 is, for instance, a display device such as a display, a projector, and a sound output device such as a speaker, and conducts a predetermined display or/and a predetermined sound output (including a playback of the digest candidate Cd) based on an output signal “S2” supplied from the information processing device 1.

The storage device 4 is a memory that stores various kinds of information necessary for processing by the information processing device 1. The storage device 4 stores, for instance, first video material data D1, second video material data D2, first inference section information D3, and second inference section information D4.

The first video material data D1 are regarded as video data generated by the first camera 8a. The second video material data D2 are regarded as video data generated by the second camera 8b. The first video material data D1 and the second video material data D2 are respective sets of video data captured during at least a partially overlapping time period. Moreover, the first video material data D1 and the second video material data D2 include meta information indicating a capturing time.

Note that the first video material data D1 and the second video material data D2 may be stored respectively in the storage device 4 via data communications from the first camera 8a and the second camera 8b, or may be stored in the storage device 4 via a portable storage medium. In these cases, the information processing device 1 may store the first video material data D1 and the second video material data D2 in the storage device 4 after receiving the first video material data D1 and the second video material data D2 via the data communications or the storage medium from the first camera 8a and the second camera 8b.

The first inference section information D3 is regarded as information concerning a first inference section being an inference section that infers a primary score (“first score”) for the input video data. The first score is regarded as, for instance, a score indicating a degree of importance with respect to the input video data, and the degree of importance described above is an index used as a reference for determining whether the input video data correspond to an important segment or a non-important segment (that is, whether or not the input video data are appropriate as a segment for the digest).

For instance, in a case where a predetermined number (one or more) of images forming the video data are input, the first inference section is trained in advance so as to infer the first score for the video data of a subject, and the first inference section information D3 includes parameters of the trained first inference section. In the present example embodiment, the information processing device 1 sequentially inputs video data (also referred to as “segmented video data”) obtained by dividing the first video material data D1 for each segment of a predetermined playback time length, to the first inference section. Note that the first inference section may infer the first score for sound data as an input included in the video data in addition to images forming the video data to be the subject. In this case, features calculated from the sound data may be input to the first inference section.

The second inference section information D4 is information concerning the second inference section being an inference section that infers a secondary score (also called a “second score”) for the video data being input. The second score is a score that indicates a probability whether or not a particular event occurs. The above-described “particular event” refers to an event that is important in an event to be captured, such as an occurrence of a particular action being important in an event (that is, a home run in a baseball game) or an occurrence of another event or the occurrence of other events (that is, an occurrence of a score in competitions that compete for scores).

For instance, for a case where a predetermined number of images forming the video data are input, the second inference section is trained in advance so as to infer the second score for the video data as the subject, and the second inference section information D4 includes the parameters of the learned second inference section. In the present example embodiment, the information processing device 1 sequentially inputs, to the second inference section, individual sets of segmented video data selected based on the first score output by the first inference section. Note that the second inference section may infer the second score using the sound data included in the video data as an input in addition to the images forming the video data to be the subject.

Each of learning models of the first inference section and the second inference section may be regarded as a learning model based on any machine learning, such as a neural network or a support vector machine. For instance, in a case where each model for the first inference section and the second inference section described above is the neural network such as a convolutional neural network, the first inference section information D3 and the second inference section information D4 include various parameters such as a layer structure, a neuron structure for each layer, the number of filters, and a filter size at each layer, and individual weights of elements for each filter.

Note that the storage device 4 may be an external storage device such as a hard disk connected to or built in the information processing device 1, or may be a storage medium such as a flash memory or the like. Moreover, the storage device 4 may be a server device that performs data communications with the information processing device 1. Furthermore, the storage device 4 may include a plurality of devices. In this case, the storage device 4 may store the video material data D1 and the inference engine information D2 in a distributed manner.

The configuration of the digest candidate selection system 100 described above is regarded as one example, and various changes may be made to the configuration. For instance, the input device 2 and the output device 3 may be formed integrally. In this case, the input device 2 and the output device 3 may be formed as a tablet type terminal integrated with the information processing device 1. In another example, the digest candidate selection system 100 may not include at least one of the input device 2 and the output device 3. In yet another instance, the information processing device 1 may be formed by a plurality of devices. In this case, the plurality of devices forming the information processing device 1 conduct sending and receiving of information necessary for executing respective pre-allocated processes among the plurality of devices.

(2) Hardware Configuration of the Information Processing Device

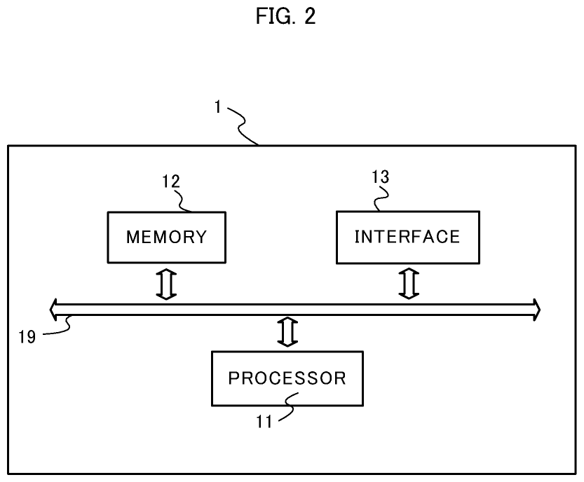

FIG. 2 illustrates a hardware configuration of the information processing device 1. The information processing device 1 includes a processor 11, a memory 12, and an interface 13 as hardware components. The processor 11, the memory 12, and the interface 13 are connected via a data bus 19.

The processor 11 executes a predetermined process by executing a program stored in the memory 12. The processor 11 corresponds to one or more processors such as a CPU (Central Processing Unit), a GPU (Graphics Processing Unit), a quantum processor, and the like.

The memory 12 is formed by various volatile and non-volatile memories such as a RAM (Random Access Memory), a ROM (Read Only Memory), and the like. In addition, a program executed by the information processing device 1 is stored in the memory 12. The memory 12 is also used as a working memory and temporarily stores information acquired from the storage device 4. Incidentally, the memory 12 may function as the storage device 4. Similarly, the storage device 4 may function as the memory 12 of the information processing device 1. Note that programs to be executed by the information processing device 1 may be stored in a recording medium other than the memory 12.

The interface 13 is an interface for electrically connecting the information processing device 1 and other devices. For instance, the interface 13 for connecting the information processing device 1 and other devices may be a communication interface such as a network adapter for sending and receiving data to and from other devices by a wired or wireless communication in accordance with a control of the processor 11. In another example, the information processing device 1 and other devices may be connected by a cable or the like. In this instance, the interface 13 includes a hardware interface compliant with a USB (Universal Serial Bus), a SATA (Serial AT Attachment), or the like for exchanging data with other devices.

Note that the hardware configuration of the information processing device 1 is not limited to the configuration depicted in FIG. 2. For instance, the information processing device 1 may include at least one of the input device 2 and the output device 3.

(3) Functional Blocks

The information processing device 1 determines a capturing time or a capturing time period (also referred to as a “reference time Tref”) as a reference for extracting the video data of the second camera based on a candidate (also referred to as “candidate video data Cd1”) of the segmented video data to be included in the digest candidate Cd. Next, the information processing device 1 generates the digest candidate Cd based on a set of video data (also referred to as a “further camera shot Sh”), which are extracted from the second video material data D2 based on the reference time Tref, and the candidate video data Cd1. In the following, functional blocks of the information processing device 1 for realizing the above-described processes will be described.

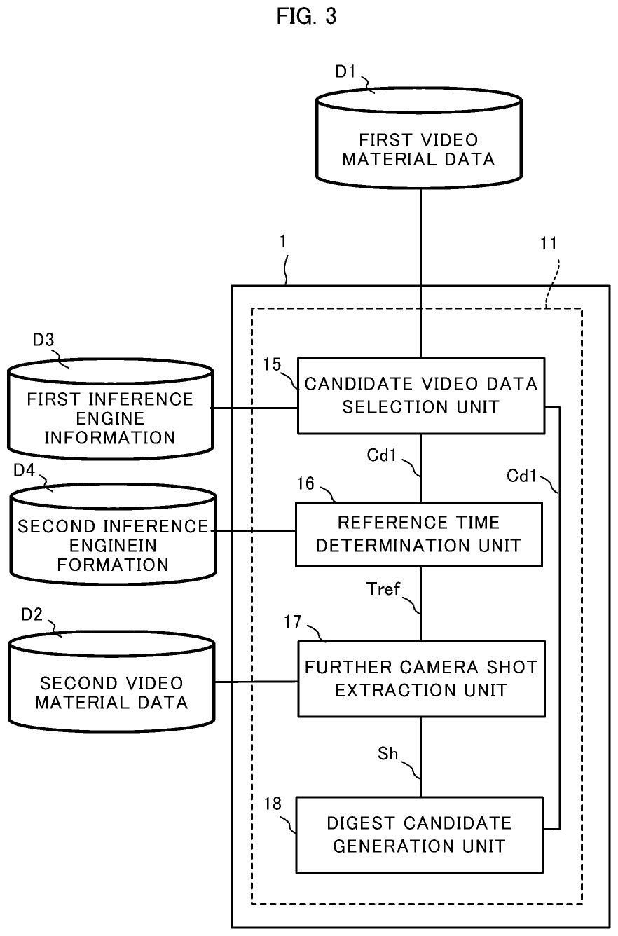

The processor 11 of the information processing device 1 functionally includes a candidate video data selection unit 15, a reference time determination unit 16, a further camera shot extraction unit 17, and a digest candidate generation unit 18. Note that in FIG. 3, blocks to exchange data are connected to each other by a solid line; however, each combination of blocks to exchange data is not limited to that depicted in FIG. 3. The same applies to diagrams of other functional blocks to be described later.

The candidate video data selection unit 15 calculates the first score for each segment with respect to the first video material data D1 obtained via the interface 13, and selects the candidate video data Cd1 based on the first score from the segmented video data. Next, the candidate video data selection unit 15 supplies the selected candidate video data Cd1 to the reference time determination unit 16 and the digest candidate generation unit 18.

In this case, first, the candidate video data selection unit 15 generates segmented video data being video data that are acquired by dividing the first video material data D1 for each segment. Here, the segmented video data correspond to, for instance, data that are acquired by dividing the first video material data D1 for each segment with a unit time length, and include a predetermined number of images. Next, the candidate video data selection unit 15 forms the first inference section by referring to the first inference section information D3, and calculates the first score with respect to the segmented video data being input by sequentially inputting sets of the segmented video data to the first inference section. Thus, the candidate video data selection unit 15 calculates the first score that is higher for segmented video data with a higher degree of importance. Accordingly, the candidate video data selection unit 15 selects, as the candidate video data Cd1, the segmented video data of which the first score is equal to or greater than a predetermined threshold value (also referred to as a “threshold value Th1”) defined in advance.

Note that in a case where the segmented video data of which the first score is equal to or greater than the threshold value Th1 form one continuous scene in time series, the candidate video data selection unit 15 may regard the segmented video data being continuous as one series of the candidate video data Cd1. In this case, the candidate video data Cd1 include at least one or more sets of the segmented video data, and is video data in which a playback time length may be different for each segment.

The reference time determination unit 16 determines the reference time Tref based on the candidate video data Cd1. Next, the reference time determination unit 16 supplies the determined reference time Tref to the further camera shot extraction unit 17.

In this case, the reference time determination unit 16 forms the second inference section by referring to the second inference section information D4, and sequentially inputs the candidate video data Cd1 to the second inference section to calculate the second score for the input candidate video data Cd1. Here, the second score indicates a higher value as a probability that a particular event has occurred is higher. Next, the reference time determination unit 16 selects the candidate video data Cd1 in which the second score is equal to or greater than a predetermined threshold value (also referred to as a “threshold value Th2”) defined in advance as the candidate video data Cd1 (also referred to as a “reference candidate video data Cd2”) to be provided with the reference time Tref. After that, the reference time determination unit 16 determines the capturing time period or the capturing time of the reference candidate video data Cd2 as the reference time Tref. In this case, in the first example, the reference time determination unit 16 sets the capturing time period of the reference candidate video data Cd2 as the reference time Tref as it is. In a second example, the reference time determination unit 16 sets a center time (or another representative time) of the capturing time period of the reference candidate video data Cd2 as the reference time Tref. The reference time Tref set in this way is a characteristic capturing time or time period with a high probability that a specific event has occurred.

The further camera shot extraction unit 17 extracts a further camera shot Sh regarded as one continuous set of video data from the second video material data D2 based on the reference time Tref, and supplies the extracted the further camera shot Sh to the digest candidate generation unit 18. In this case, the further camera shot extraction unit 17 detects two time points (also referred to as “switching points”) at which a change or a switch of a video or sound occurs in the second video material data D2, based on the reference time Tref. Next, the further camera shot extraction unit 17 extracts, as the further camera shot Sh, the video data corresponding to a segment of the second video material data D2, which is determined by the two switching points being detected. Here, each of the switching points may correspond to a time point at which a capturing subject is switched to another subject between consecutive images forming the second video material data D2, or may correspond to a time point at which a volume of the sound included in the second video material data D2 is greatly changed. Thereafter, one switching point serving as a start point of the further camera shot Sh is referred to as a first switching point, and another switching point serving as an end point of the further camera shot Sh is referred to as a second switching point.

The digest candidate generation unit 18 generates the digest candidate Cd based on the candidate video data Cd1 supplied from the candidate video data selection unit 15 and the further camera shot Sh supplied from the further camera shot extraction unit 17. For instance, the digest candidate generation unit 18 generates one set of video data connecting all sets of the candidate video data Cd1 and all further camera shots Sh as the digest candidate Cd. In this case, the digest candidate generation unit 18 generates, for instance, a digest candidate Cd in which the candidate video data Cd1 and the further camera shots Sh are arranged in time series and connected for each scene.

Note that, instead of generating one set of video data as the digest candidate Cd, the digest candidate generation unit 18 may generate a list of the candidate video data Cd1 and one or more further camera shots Sh as the digest candidate Cd. In this case, the digest candidate generation unit 18 may display the digest candidate Cd on the output device 3, and receive inputs of the user or the like for selecting the video data to be included in a final digest by the input device 2. Moreover, the digest candidate generation unit 18 may generate the digest candidate Cd using only a portion of the selected candidate video data Cd1 and one or more further camera shots Sh.

The digest candidate generation unit 18 may store the generated digest candidate Cd in the storage device 4 or the memory 12, and may send the generated digest candidate Cd to an external device other than the storage device 4. Moreover, the digest candidate generation unit 18 may playback the digest candidate Cd on the output device 3 by transmitting the output signal S2 for playing back the digest candidate Cd to the output device 3.

Noted that each component of the candidate video data selection unit 15, the reference time determination unit 16, the further camera shot extraction unit 17, and the digest candidate generation unit 18, which are described with reference to FIG. 3, can be realized, for instance, by the processor 11 executing programs stored in the storage device 4 or the memory 12. In addition, the necessary programs may be recorded in any non-volatile storage medium and installed as necessary to realize individual components. Incidentally, these components are not limited to being implemented by software by respective programs, and may be implemented by any combination of hardware, firmware, and software. Alternatively, each of these components may also be implemented using the user programmable integrated circuit such as an FPGA (field-programmable gate array), a microcomputer, or the like. In this case, the integrated circuit may be used to realize programs formed by the above-described components. Accordingly, each of the components may be implemented by any controller including hardware other than a processor. The above explanations are similarly applied to other example embodiments to be described later.

(4) Concrete Example

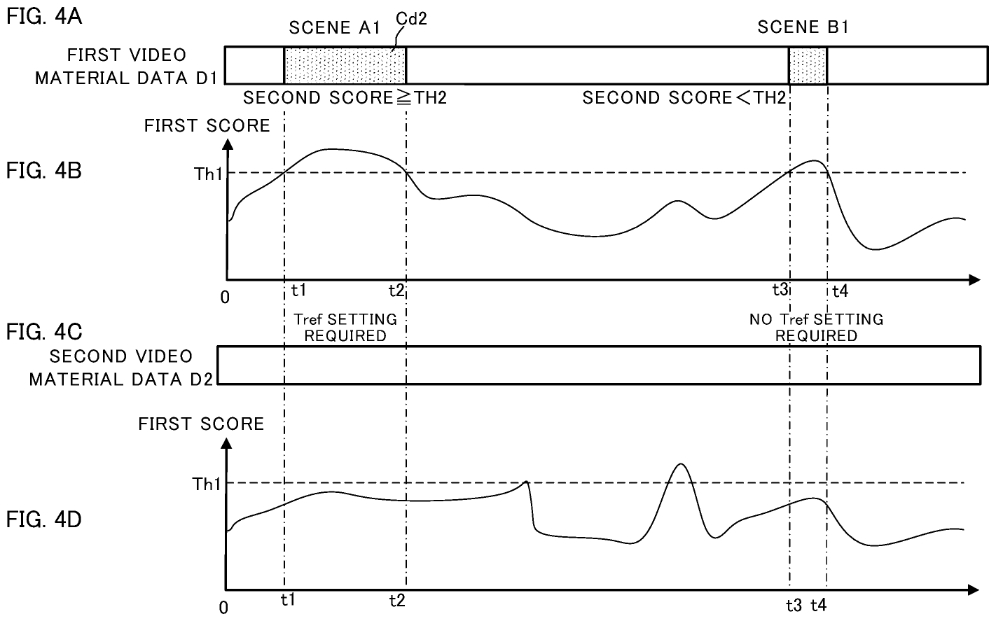

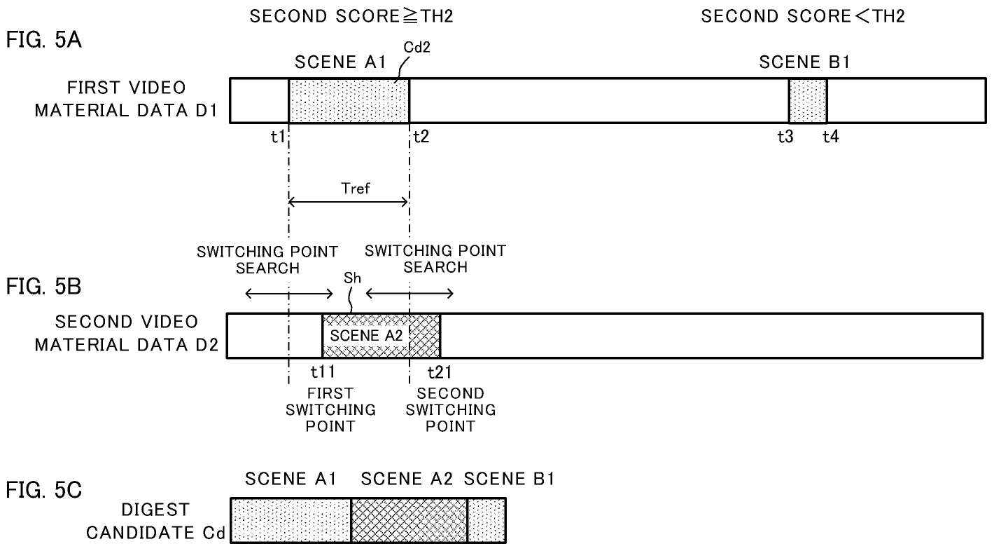

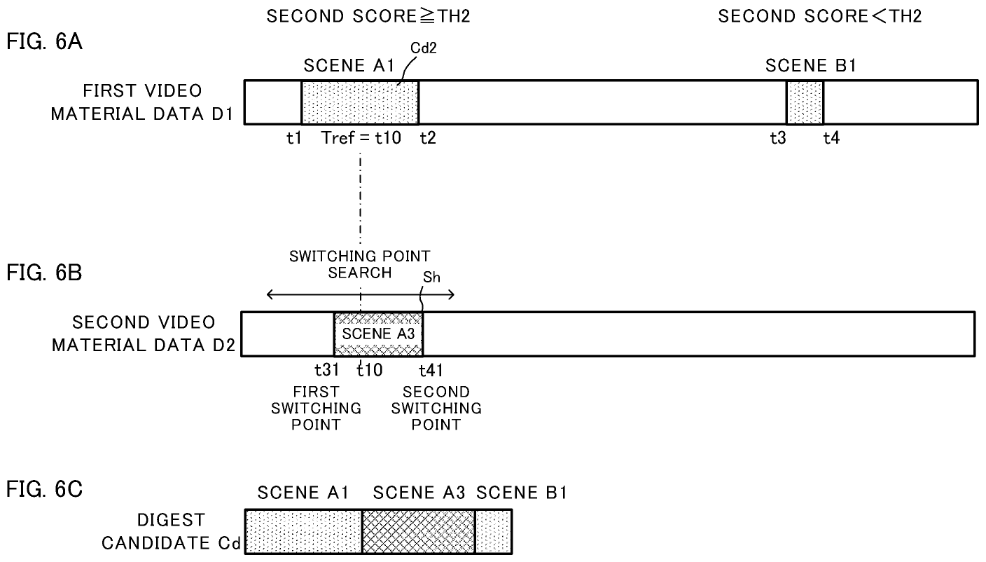

Next, a specific example for generating of the digest candidate Cd based on the functional blocks depicted in FIG. 3 will be described with reference to FIG. 4A through FIG. 4D, FIG. 5A through FIG. 5C, and FIG. 6A through FIG. 6C.

FIG. 4A is a diagram illustrating the first video material data D1 by a band graph with a length corresponding to a playback time length of the first video material data D1 (that is, the number of frames). FIG. 4B illustrates a line graph representing the first score in time series for the first video material data D1. FIG. 4C is a diagram illustrating the second video material data D2 by a band graph with a length corresponding to a playback time length of the second video material data D2. FIG. 4D illustrates a line graph representing the first score in time series for the second video material data D2.

As illustrated in FIG. 4A and FIG. 4B, the candidate video data selection unit 15 determines that the first scores for sets of segmented video data corresponding to a “scene A1” and a “scene B1” are equal to or greater than the threshold value Th1, and selects these sets of segmented video data as the candidate video data Cd1. Here, the candidate video data selection unit 15 determines the candidate video data Cd1 for each continuous set of the segmented video data in which the first score is equal to or greater than the threshold value Th1. In an example in FIG. 4A, each of the scene A1 and the scene B1 corresponds to a scene in which one or more sets of segmented video data, for which each first score is equal to or greater than the threshold value Th1, are continued. Therefore, the candidate video data selection unit 15 determines the scene A1 corresponding to a segment from a playback time “t1” to a playback time “t2” of the first video material data D1, and the scene B1 corresponding to a segment from a playback time “t3” to a playback time “t4” of the first video material data D1, respectively, as sets of the candidate video data Cd1.

Next, the reference time determination unit 16 calculates each second score for sets of the candidate video data Cd1 respectively forming the scene A1 and the scene B1, and regards the candidate video data Cd1 of which the second score is equal to or greater than the threshold value Th2 as the reference candidate video data Cd2. Here, the reference time determination unit 16 determines that the second score of the candidate video data Cd1 corresponding to the scene A1 is equal to or greater than the threshold value Th2, and that the second score of the candidate video data Cd1 corresponding to the scene B1 is lower than the threshold value Th2. Therefore, in this case, the reference time determination unit 16 regards the scene A1 as the reference candidate video data Cd2, and sets the reference time Tref.

Here, the reference time determination unit 16 calculates the second score for each candidate video data Cd1 by inputting the candidate video data Cd1 to the second inference section which is formed by referring to the second inference section information D4. At this time, in a case where the candidate video data Cd1 is formed by a plurality of sets of segmented video data, the reference time determination unit 16 may divide the candidate video data Cd1 for each segment, sequentially input the segmented data into the second inference section, and conduct a statistical process such as averaging of inference results of the second inference section, so as to calculate the above-described second score.

Next, a generation example of the digest candidate Cd in a case of setting a time period as the reference time Tref will be described.

FIG. 5A illustrates a band graph of the same first video material data D1 depicted in FIG. 4A. FIG. 5B illustrates a band graph of the second video material data D2 that explicitly indicates the further camera shot Sh. FIG. 5C illustrates a band graph of the digest candidate Cd generated based on the first video material data D1 depicted in FIG. 5A and the second video material data D2 depicted in FIG. 5B.

In this case, the reference time determination unit 16 sets, as the reference time Tref, the capturing time period (that is, the time period from the time t1 to the time t2) of the scene A1 that is determined to be the reference candidate video data Cd2.

The further camera shot extraction unit 17 extracts “scene A2” of the second video material data D2 as a further camera shot Sh based on the reference time Tref. In this case, the further camera shot extraction unit 17 searches for the first switching point serving as a start point of the further camera shot Sh as a start point t1 of the further camera shot reference time Tref is reference, and searches for the second switching point serving as the end point of the further camera shot Sh as an end point t2 of the reference time Tref. Next, the further camera shot extraction unit 17 detects a time “t11” being a switching point of the second video material data D2 closest to the time t1 as the first switching point, and detects a time “t21” being another switching point of the second video material data D2 closest to the time t2 as the second switching point. After that, the further camera shot extraction unit 17 extracts the scene A2 specified by the first switching point and the second switching point as the further camera shot Sh.

Next, as illustrated in FIG. 5C, the digest candidate generation unit 18 generates a digest candidate Cd in which the scene A1 and the scene B1 being sets of candidate video data Cd1 and the scene A2 being the further camera shot Sh are connected in time series. In this case, the digest candidate generation unit 18 continuously incorporates video data being continuous in time series, which are extracted from the same video material data into the digest candidate Cd, without separating. In an example in FIG. 5C, the scene A1, the scene A2, and the scene B1 correspond to respective sets of the video data being continuous in time series so that the digest candidate generation unit 18 incorporates these scenes into the digest candidate Cd as respective continuous scenes. Therefore, it is possible to prevent the digest candidate generation unit 18 from generating an unnatural digest candidate Cd.

Next, an example for generating the digest candidate Cd will be described in a case of setting time as the reference time Tref.

FIG. 6A illustrates a band graph of the same first video material data D1 as that in FIG. 4A. FIG. 6B illustrates a band graph of the second video material data D2 that explicitly indicates the further camera shot Sh. FIG. 6C illustrates a band graph of the digest candidate Cd generated based on the first video material data D1 depicted in FIG. 6A and the second video material data D2 depicted in FIG. 6B.

In this case, the reference time determination unit 16 sets, as the reference time Tref, the representative time “t10” of the capturing time period of the scene A1 where a setting of the reference time Tref is determined to be required. Here, the time t10 is an intermediate time between the start time t1 and the end time t2 of the capturing time period.

Next, the further camera shot extraction unit 17 extracts the further camera shot Sh based on the reference time Tref, the “scene A3” of the second video material data D2. In this case, for instance, the further camera shot extraction unit 17 searches the second switching point from a time later than the reference time Tref. Next, the further camera shot extraction unit 17 detects, as the first switching point, a time “t31” which is the closest switching point at a time prior to the time t10 being the reference time Tref, and detects, as the second switching point, a time “t41” which is the closest switching point at a time later than the time t10. After that, as illustrated in FIG. 6C, the digest candidate generation unit 18 generates a digest candidate Cd connecting the scene A1 and the scene B1 which are sets of the candidate video data Cd1, and the scene A3 which is the further camera shot Sh, in time series.

Here, both the scene A2 being a further camera shot Sh included in the digest candidate Cd depicted in FIG. 5C and the scene A3 being another further camera shot Sh included in the digest candidate Cd depicted in FIG. 6C correspond to segments of the second video material data D2 of which the first score is lower than the threshold value Th1 (refer to FIG. 4D). Accordingly, it is possible for the information processing device 1 to preferably include video data of the second camera corresponding to an important scene in the digest candidate Cd, regardless of the first score, even in a case where the reference time Tref is either a time period or time.

Here, the method for detecting the switching point described with reference to FIG. 5B and FIG. 6B will be supplementally described.

For instance, the further camera shot extraction unit 17 calculates an index value (for example, a total value of brightness differences among respective pixels) based on differences in a distribution of brightness among consecutive images or among images spaced by a predetermined number of images in the second video material data D2. Next, the further camera shot extraction unit 17 detects a time between the images of interest as the switching point in a case where the calculated index value is equal to or greater than a predetermined threshold value. In another example, the further camera shot extraction unit 17 calculates each of differences corresponding to the number of edges being detected among consecutive images or between images spaced by the predetermined number of images in the second video material data D2. Subsequently, the further camera shot extraction unit 17 detects the time between the target images as the switching point for the calculated difference that is equal to or greater than a predetermined threshold value.

In yet another example, the further camera shot extraction unit 17 calculates a sound volume in time series of the first video material data D1, and detects, as the switching point, a time at which a degree of a change of the sound volume is equal to or greater than a predetermined threshold value. Note that the further camera shot extraction unit 17 may arbitrarily combine methods for detecting the switching point. In this case, for instance, the further camera shot extraction unit 17 detects the switching point by comparing the index value calculated for each of the detection methods to be employed with threshold values respectively prepared (or by comparing a total index value of these index values with a single threshold value).

(5) Training of the First Inference Section and the Second Inference Section

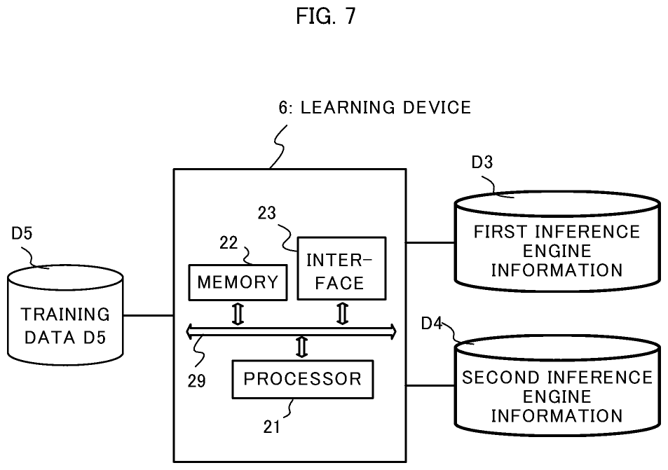

Next, a case of generating the first inference section information D3 and the second inference section information D4 by training the first inference section and the second inference section will be described. FIG. 7 illustrates a schematic configuration diagram of a learning system for training the first inference section and the second inference section. The learning system has a learning device 6 which can refer to training data D5.

The learning device 6 has the same configuration as that of the information processing device 1 depicted in FIG. 2, for instance, and mainly includes a processor 21, a memory 22, and an interface 23. The learning device 6 may be an information processing device 1, and may be any device other than the information processing device 1.

The training data D5 includes sets of training material data that are material data for training, first labels that are regarded as respective correct labels concerning the first scores for the training material data, and second labels that are respective correct labels concerning the second scores for the training material data.

For instance, the first label is information for discriminating between an important segment and a non-important segment in the training material data. For instance, the second label is information for identifying a segment in which a particular event has occurred in the training material data. In another example, similar to first label, the second label may be information for identifying the important segment and the non-important segment in the training material data. Note that sets of the training material data may be respectively provided in the training of the first inference section and the training of the second inference section.

Next, the learning device 6 refers to the training data D5 and performs the training of the first inference section based on sets of the training material data and respective first labels. In this case, the learning device 6 determines parameters of the first inference section so that an error (a loss) between each output of the first inference section when the segmented video data extracted from the training material data are input to the first inference section and the first score with respect to the correct answer indicated by the first label corresponding to the input data is minimized. An algorithm for determining the parameters described above to minimize the loss may be any learning algorithm used in machine learning, such as a gradient descent method or an error back propagation method. Noted that the learning device 6 may set the first score of the correct answer as a maximum value of the first score for the segmented video data of the training material data designated as the important segment by the first label, and may set the first score of the correct solution as a minimum value of the first score for other sets of segmented video data.

In a similar manner, the learning device 6 refers to the training data D5 and performs the training of the second inference section based on sets of the training material data and respective second labels. In this case, the learning device 6 determines parameters of the second inference section so that an error (a loss) between each output of the second inference section when the segmented video data extracted from the training material data are input to the second inference section and the second score of the correct answer indicated by the second label corresponding to the input data is minimized.

Next, the learning device 6 generates the parameters of the first inference section obtained by learning as the first inference section information D3, and generates the parameters of the second inference section obtained by learning as the second inference section information D4. The generated first inference section information D3 and the generated second inference section information D4 may be immediately stored in the storage device 4 by data communications between the storage device 4 and the learning device 6, or may be stored in the storage device 4 through a removable storage medium.

Note that the first inference section and the second inference section may be trained respectively by separate devices. In this case, the learning device 6 is formed by a plurality of devices that respectively perform the training of the first inference section and the training of the second inference section. Moreover, the first inference section and the second inference section may be trained for each type of an event which has been captured for the training material data.

(6) Process Flow

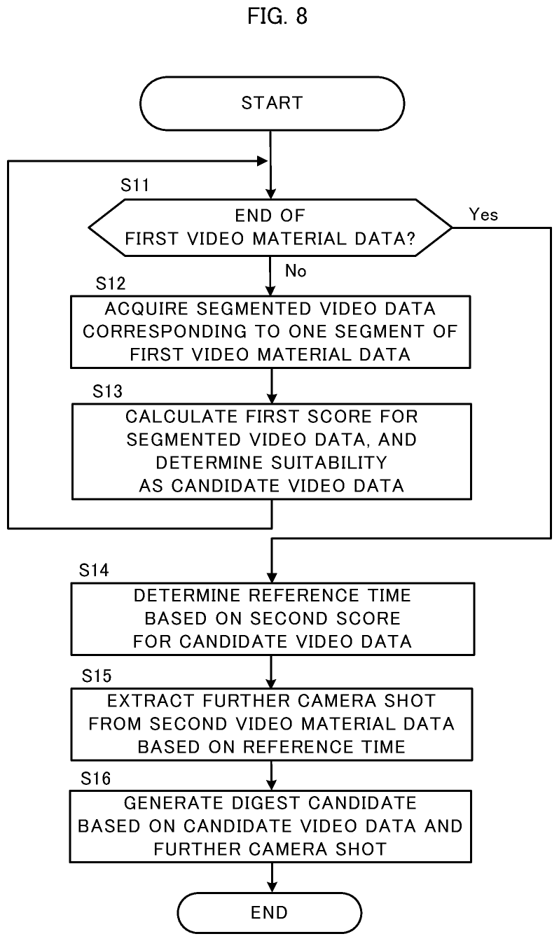

FIG. 8 illustrates an example of a flowchart for explain steps in a process executed by the information processing device 1 in the first example embodiment. The information processing device 1 executes the process of the flowchart depicted in FIG. 8, for instance, in response to a detection of an input by a user who instructs a start of the process by designating the first video material data D1 and the second video material data D2 of interest.

First, the information processing device 1 determines whether or not it is an end of the first video material data D1 (step S11). In this case, the information processing device 1 determines that it is the end of the first video material data D1 when processes of step S12 and step S13 to be described later are carried out for all segments of the first video material data D1 of interest. Next, the information processing device 1 advances this process to step S14 when it is the end of the first video material data D1 (step S11; Yes). On the other hand, when it is not the end of the first video material data D1 (step S11; No), the information processing device 1 executes step S12 and step S13 for the segmented video data of the first video material data D1 for which step S12 and step S13 have not been processed.

In step S12, the candidate video data selection unit 15 of the information processing device 1 acquires the segmented video data corresponding to one segment of the first video material data D1 (step S12). For instance, the candidate video data selection unit 15 acquires the segmented video data of the first video material data D1 for which the processes of step S12 and step S13 have not been performed, in an order of earlier playback time.

Next, the candidate video data selection unit 15 calculates the first score for the segmented video data acquired in step S12, and determines whether or not the segmented video data are the candidate video data Cd1 (step S13). In this case, when the first score calculated by inputting the segmented video data to the first inference section formed with reference to the first inference section information D3 is equal to or greater than the threshold value Th1, the candidate video data selection unit 15 considers that the segmented video data are the candidate video data Cd1. On the other hand, when the first score of the segmented video data is lower than the threshold value Th1, the candidate video data selection unit 15 considers that the segmented video data are not the candidate video data Cd1. Subsequently, the information processing device 1 goes back to step S11, and repeats step S12 and step S13 until the end of the first video material data D1, so as to determine whether or not each set of segmented video data forming the first video material data D1 is suitable for the candidate video data Cd1.

In step S14, the reference time determination unit 16 determines the reference time Tref based on the second score with respect to the candidate video data Cd1 selected in step S13. In this case, the reference time determination unit 16 calculates the second score by inputting the candidate video data Cd1 to the second inference section formed with reference to the second inference section information D4. Next, the reference time determination unit 16 regard, as the reference candidate video data Cd2, the candidate video data Cd1 of which the second score is equal to or greater than the threshold value Th2, and determines the capturing time period or the representative time of the reference candidate video data Cd2 as the reference time Tref.

Subsequently, the further camera shot extraction unit 17 extracts the further camera shot Sh from the second video material data D2 based on the reference time Tref determined by step S14 (step S15). Therefore, it is possible for the further camera shot extraction unit 17 to preferably extract, as the further camera shot Sh, video data captured by the second camera 8b in a time period during which a predetermined event is likely to have occurred.

Next, the digest candidate generation unit 18 generates the digest candidate Cd based on the candidate video data Cd1 selected in step S13 and the further camera shot Sh selected in step S15 (step S16). In this case, for instance, the digest candidate generation unit 18 generates, as the digest candidate Cd, the video data obtained by connecting the candidate video data Cd1 and the further camera shot Sh in time series. In another example, the digest candidate generation unit 18 generates a list of the candidate video data Cd1 and the further camera shot Sh as the digest candidate Cd.

Here, advantages according to the present example embodiment will be supplementarily described.

In a view of two needs of time reduction and content expansion for a sports video editing, a need for automatic editing of the sports video has been increased. In an automatic editing technology, in a case of detecting an important scene from the input image, it is determined that the scene is important for one camera, but it may not be determined that the scene is important for another camera at the same certain time. In this case, the important scene may be missed from another camera, and the important scene may not be produced effectively.

In view of the above, the information processing device 1 according to the first example embodiment also includes video data of the second camera 8b, which are captured in the same time period as the important scene captured by the first camera 8a being the main camera, in the digest candidate Cd. Accordingly, it is possible for the information processing device 1 to preferably generate the digest candidate Cd using sets of video data from a plurality of cameras for the important scene. Hence, it is possible to generate a digest image that impresses viewers. For instance, the information processing device 1 may include, in the digest candidate Cd, video data of the second camera 8b (a lower camera) that mainly captures a player holding a ball from the same time to a few seconds later for a scene which is determined to be important and captured by the first camera 8a (such as an upper camera in a soccer game) that captures an overview of the entire scene. By these scenes, it is possible for the information processing device 1 to preferably generate the digest candidate Cd incorporating a scene, in which a shot is scored at another angle, and a goal performance.

(7) Modifications

Next, each of modifications preferable for the above example embodiment will be described. The following modifications may be combined arbitrarily and applied to the above-described example embodiment.

(Modification 1)

The information processing device 1 may select the candidate video data Cd1 for setting the reference time Tref based on the first score calculated by referring to the first inference section information D3 without referring to the second inference section information D4.

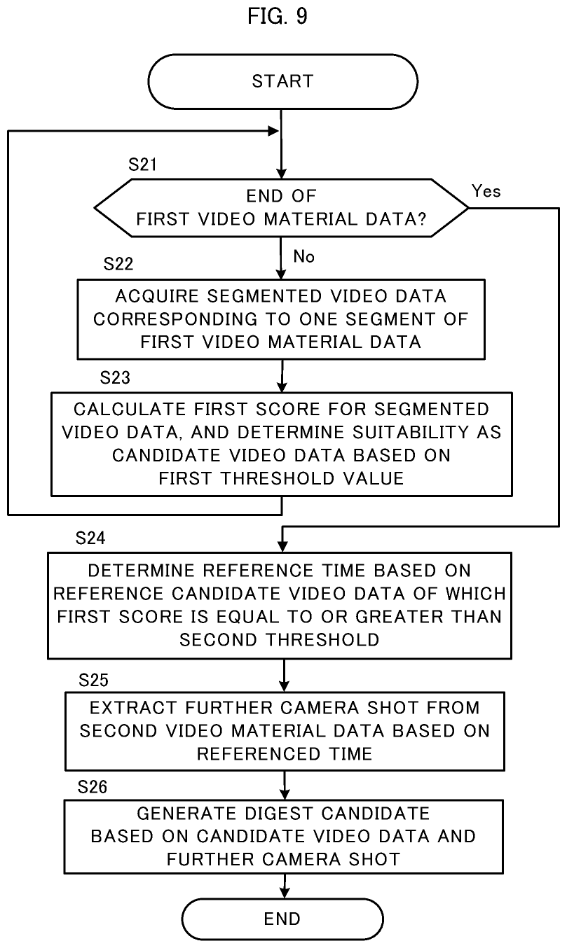

FIG. 9 illustrates an example of a flowchart in which the information processing device 1 executes in Modification 1. In the flowchart in FIG. 9, the information processing device 1 performs a selection of the candidate video data Cd1 and a selection of the reference candidate video data Cd2, by setting two threshold values (a first threshold value Th11 and a second threshold value Th12) for the first score.

First, the candidate video data selection unit 15 of the information processing device 1 performs step S21 to step S23 in a similar manner to step S11 to step S13 in FIG. 8 so as to select segmented video data to be the candidate video data Cd1. In this case, in step S23, the candidate video data selection unit 15 selects the segmented video data of which the first score is equal to or greater than the first threshold value Th11 as the candidate video data Cd1.

After that, the reference time determination unit 16 determines the reference time Tref based on the reference candidate video data Cd2 in which the first score is equal to or greater than the second threshold value Th12 (step S24). In this case, the second threshold value Th12 is set as a value higher than the first threshold value Th11. Therefore, in this case, the reference time determination unit 16 selects the reference candidate video data Cd2 having a particularly high degree of importance among sets of the candidate video data Cd1 selected in step S23 based on the second threshold value Th12, and provides the reference time Tref for the selected reference candidate video data Cd2.

Thereafter, the further camera shot extraction unit 17 extracts the further camera shot Sh from the second video material data D2 based on the reference time Tref (step S25). Subsequently, the digest candidate generation unit 18 generates the digest candidate Cd based on the candidate video data Cd1 and the further camera shot Sh (step S26).

According to this modification, the information processing device 1 may preferably include the further camera shot Sh of the second video material data D2 corresponding to a scene of the particularly high degree of importance in the first video material data D1 in the digest candidate Cd.

(Modification 2)

The information processing device 1 may extract video data of the second video material data D2 during the same capturing time period as the reference candidate video data Cd2 for setting the reference time Tref, as the further camera shot Sh.

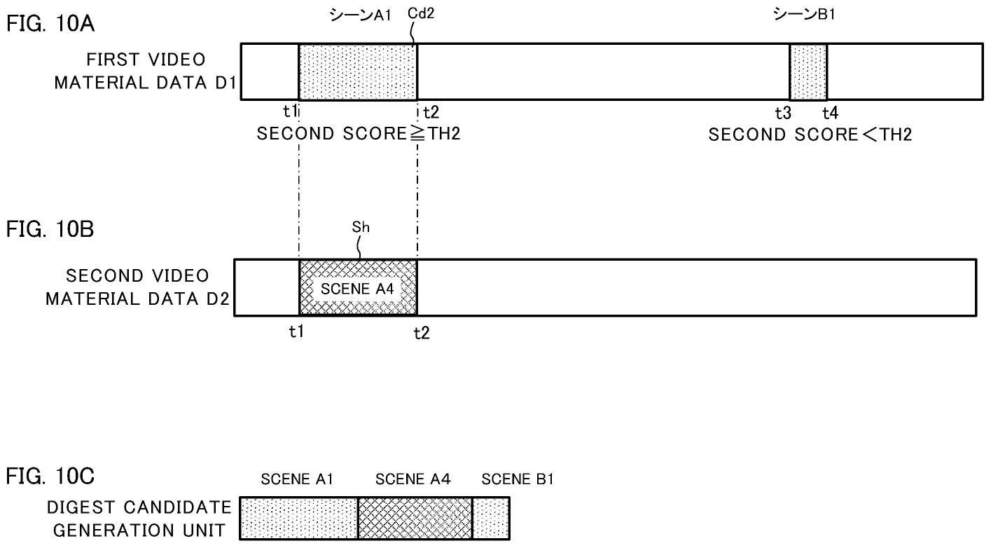

FIG. 10A illustrates a band graph of the same first video material data D1 depicted in FIG. 4A and FIG. 5A. FIG. 10B illustrates a band graph of the second video material data D2 that explicitly indicates a further camera shot Sh. FIG. 10C illustrates a band graph of the generated digest candidate Cd.

In this case, the reference time determination unit 16 sets, as the reference time Tref, the capturing time period (time period from the time t1 to the time t2) of the scene A1 in which the candidate video data Cd1, of which the first score is equal to or greater than the threshold value Th1, are continuous. Next, the further camera shot extraction unit 17 extracts, as the further camera shot Sh, a “scene A4” in the second video material data D2 during the capturing time period from the time t1 corresponding to the reference time Tref to the time t2. After that, the digest candidate generation unit 18 generates a digest candidate Cd that connects the scene A4 and the scene B1 which are candidate video data Cd1 and the scene A4 which is the further camera shot Sh in time series. In this case, the scene A4 being the further camera shot Sh and the scene A1 being the candidate video data Cd1 corresponding to the scene A4 appear during the same capturing time period.

Accordingly, in this modification, the information processing device 1 extracts the further camera shot Sh from the second video material data D2 without detecting a switching point. Then, it is possible to preferably include, in the digest candidate Cd, a scene captured by the second camera 8b in the same time period as that of the important scene captured by the first camera 8a.

(Modification 3)

The information processing device 1 may generate a digest candidate Cd based on the first video material data D1 to which a label for identifying whether or not a segment is important is provided in advance. In this case, instead of selecting the candidate video data Cd1 by referring to the first inference section information D3, the information processing device 1 selects the candidate video data Cd1 by referring to the label described above.

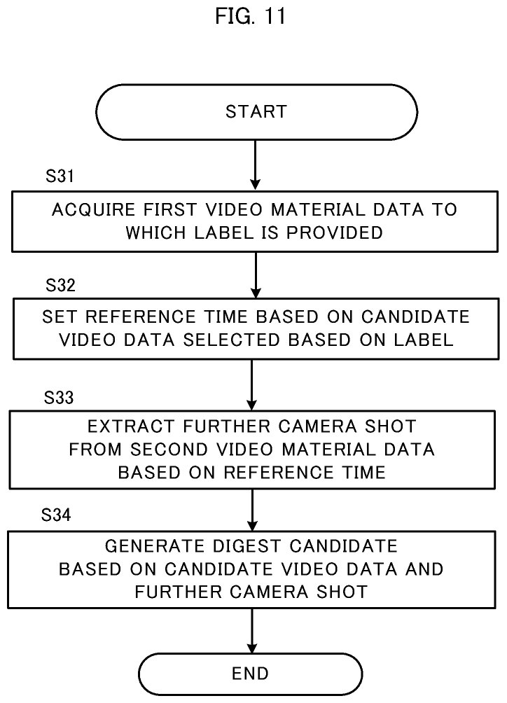

FIG. 11 illustrates an example of a flowchart for a process executed by the information processing device 1 in Modification 3. First, the candidate video data selection unit 15 of the information processing device 1 acquires the first video material data D1 to which the label identifying whether or not a segment is the important segment, from the storage device 4 (step S31).

Next, the reference time determination unit 16 sets the reference time Tref based on the candidate video data Cd1 selected based on the label provided to the first video material data D1 (step S32). In this case, the candidate video data selection unit 15 regards video data of the important segment identified based on the label provided to the first video material data D1 as the candidate video data Cd1. Thereafter, the reference time determination unit 16 selects the reference candidate video data Cd2 from the candidate video data Cd1 based on the second score, and sets the reference time Tref corresponding to the capturing time period of the reference candidate video data Cd2. Note that the reference time determination unit 16 may set the reference time Tref corresponding to the capturing time period of all of the candidate video data Cd1 without selecting the reference candidate video data Cd2, as explained in Modification 5 to be described later.

After that, the further camera shot extraction unit 17 extracts a further camera shot Sh from the second video material data D2 based on the reference time Tref (step S33). Subsequently, the digest candidate generation unit 18 generates the digest candidate Cd based on the candidate video data Cd1 and the further camera shot Sh (step S34).

As described above, even in this modification, it is possible for the information processing device 1 to preferably generate the digest candidate Cd including the further camera shot Sh generated by the second camera 8b. Moreover, in the present modification, the information processing device 1 generates the digest candidate Cd without using the first inference section information D3.

(Modification 4)

The information processing device 1 may generate a digest candidate Cd based on video data generated by three or more cameras.

In this case, the further camera shot extraction unit 17 extracts the further camera shot Sh from the second video material data D2, and extracts other camera shots Sh respectively from sets of video material data captured by cameras other than the first camera 8a and the second camera 8b. In this case, for instance, the further camera shot extraction unit 17 extracts other camera shots Sh for the respective sets of video material data by detecting the first switching point and the second switching point for each set of video material data based on the reference time Tref. In another example, the further camera shot extraction unit 17 may extract sets of video data during the same capturing time period as that of the reference candidate video data Cd2 from the respective sets of video material data as the other camera shots Sh based on Modification 2. After that, the digest candidate generation unit 18 generates the digest candidate Cd based on the further camera shots Sh extracted from the respective sets of video material data and the candidate video data Cd1.

Therefore, it is possible for the information processing device 1 to preferably generate the digest candidate Cd based on sets of video data generated by the three or more cameras.

(Modification 5)

The information processing device 1 does not need to select the candidate video data Cd1 for setting the reference time Tref.

In this case, instead of selecting a portion of the candidate video data Cd1 as the reference candidate video data Cd2, all of the candidate video data Cd1 are regarded as the reference candidate video data Cd2. Specifically, instead of using the second score, the reference time determination unit 16 sets the reference time Tref based on the capturing time period of all the candidate video data Cd1 in step S14 in FIG. 8. Also in this manner, it is possible for the information processing device 1 to preferably include a further camera shot Sh of the second video material data D2 corresponding to a scene for which a degree of importance is high in the first video material data D1, in the digest candidate Cd.

(Modification 6)

The information processing device 1 may calculate the first score in time series with respect to the second video material data D2, similar to the first video material data D1, and may include video data (a scene) of a segment of the second video material data D2 of which the first score is equal to or greater than the threshold value Th1, in the digest candidate Cd.

### Second Example Embodiment

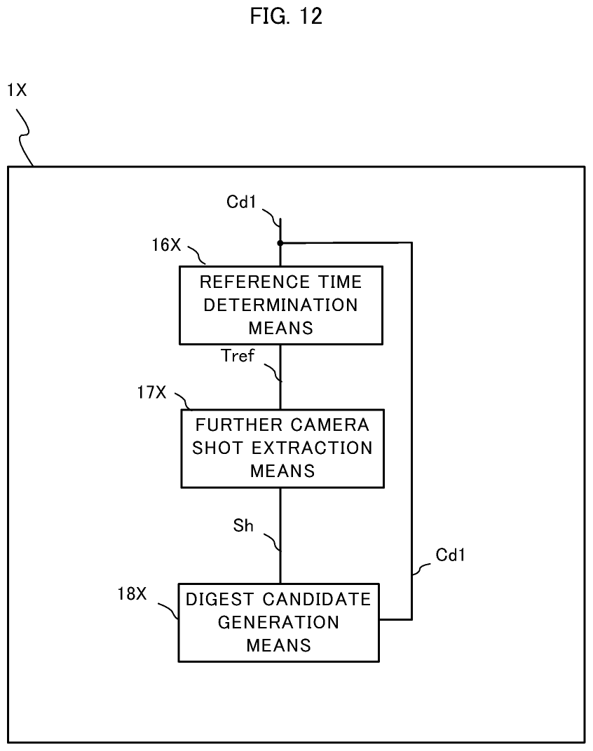

FIG. 12 illustrates a functional block diagram of an information processing device 1X according to a second example embodiment. The information processing device 1X mainly includes a reference time determination means 16X, a further camera shot extraction means 17X, and a digest candidate generation means 18X.

The reference time determination means 16X determines a reference time “Tref” which is a reference time or a time period for extracting video data of the second camera different from the first camera based on the candidate video data “Cd1” which is to be a candidate for a digest of the first video material data captured by the first camera. The reference time determination means 16X may be a reference time determination means 16 in the first example embodiment (including the modifications, the same below). Here, the reference time determination means 16X may receive the candidate video data Cd1 from other components in the information processing device 1X that selects the candidate video data Cd1, and may receive the candidate video data Cd1 from an external device (that is, a device other than the information processing device 1X) that selects the candidate video data Cd1.

The further camera shot extraction means 17X extracts a further camera shot “Sh” that is a portion of the video data of the second video material data captured by the second camera based on the reference time Tref. The further camera shot extraction means 17X may be the further camera shot extraction means 17 in the first example embodiment.

The digest candidate generation means 18X generates a digest candidate “Cd” which is a candidate of the digest for the first video material data and the second video material data based on the candidate video data Cd1 and the further camera shot Sh. Here, the digest candidate generation means 18X may be a digest candidate generation means 18 in the first example embodiment. For instance, the digest candidate generation means 18X generates a digest candidate Cd which is one set of video data combining the candidate video data Cd1 and the further camera shot Sh. In another instance, the digest candidate generation means 18X may generate a list of the candidate video data Cd1 and the further camera shot Sh as the digest candidate Cd. Incidentally, the digest candidate Cd may include video data other than the candidate video data Cd1 and the further camera shot Sh.

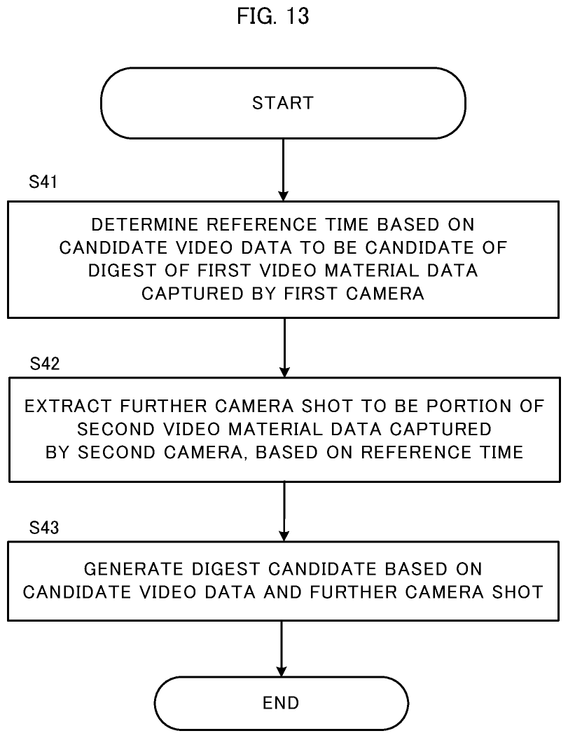

FIG. 13 illustrates an example of a flowchart of a process executed by the information processing device 1X in the second example embodiment. First, the reference time determination means 16X determines the reference time Tref regarded as the reference time or the time period for extracting video data of the second camera based on the candidate video data Cd1 which correspond to a candidate for the digest of the first video material data captured by the first camera (step S41). Next, the further camera shot extraction means 17X extracts a further camera shot Sh which is a portion of the video data of the second video material data captured by the second camera based on the reference time Tref (step S42). After that, the digest candidate generation means 18X generates the digest candidate Cd based on the candidate video data Cd1 and the further camera shot Sh (step S43).

The information processing device 1X according to the second example embodiment can preferably generate the digest candidate including videos captured by a plurality of cameras.

In the example embodiments described above, programs may be stored using various types of non-transitory computer readable media (non-transitory computer readable media), and can be supplied to a computer such as a processor. The non-transitory computer-readable media include various types of tangible storage media (tangible storage media). Examples of non-transitory computer readable media include a magnetic storage medium (that is, a flexible disk, a magnetic tape, a hard disk drive), a magnetic optical storage medium (that is, a magnetic optical disk), a CD-ROM (Read Only Memory), a CD-R, a CD-R/W, a semiconductor memory (that is, a mask ROM, a PROM (Programmable ROM), an EPROM (Erasable PROM), a flash ROM, a RAM (Random Access Memory), and the like. Each program may also be provided to the computer by various types of transitory computer readable media (transitory computer readable media). In the examples of the transitory computer readable media, recording means include electrical signals, optical signals, and electromagnetic waves. The transitory computer readable media can provide the programs to the computer through wired channels such as electrical wires and optical fibers, or wireless channels.

A part or all of the example embodiments described above may also be described as the following supplementary notes, but not limited thereto.

(Supplementary Note 1)

1. An information processing device comprising:

a reference time determination means configured to determine a reference time that indicates a time or a time period to be a reference for extracting video data of a second camera different from a first camera, based on candidate video data to be a candidate of a digest of first video material data captured by the first camera;

a further camera shot extraction means configured to extract a further camera shot to be video data of a portion of second video material data captured by the second camera, based on the reference time; and

a digest candidate generation means configured to generate a digest candidate that is a candidate of a digest with respect to the first video material data and the second video material data, based on the candidate video data and the further camera shot.

(Supplementary Note 2)

2. The information processing device according to supplementary note 1, wherein the further camera shot extraction means detects a switching point where a change or a switch regarding a video or sound occurs based on the reference time, and extracts the further camera shot.

(Supplementary Note 3)

3. The information processing device according to supplementary note 2, wherein the further camera shot extraction means extracts the further camera shot based on a first switching point of the second video material data searched with reference to a start point of the time period and a second switching point of the second video material data searched with reference to an end point of the time period, in a case where the reference time indicates the time period.

(Supplementary Note 4)

4. The information processing device according to supplementary note 1, wherein the further camera shot extraction means extracts, as the further camera shot, video data of the second video material data corresponding to the time period indicated by the reference time.

(Supplementary Note 5)

5. The information processing device according to any one of supplementary notes 1 through 4, further comprising a candidate video data selection means configured to select the candidate video data from the first video material data, based on a first score in time series corresponding to the first video material data.

(Supplementary Note 6)

6. The information processing device according to supplementary note 5, wherein the reference time determination means selects reference candidate video data being the candidate video data used to determine the reference time, based on the first score with respect to the candidate video data and a second score different from the first score.

(Supplementary Note 7)

7. The information processing device according to supplementary note 5 or 6, wherein

the candidate video data selection means selects the candidate video data based on the first score acquired by inputting segmented video data for each of segments of the first video material data to a first inference section that is trained to infer the first score with respect to video data being input, and

the reference time determination means selects the reference candidate video data based on the second score acquired by inputting the candidate video data with respect to a second inference section that is trained to infer the second score with respect to the video data being input.

(Supplementary Note 8)

8. The information processing device according to supplementary note 7, wherein

the first inference section is an inference section trained based on training video material data to which a label concerning an important segment or not is provided, and

the second inference section is an inference section trained based on training video material data to which a label concerning whether a particular event has been occurred is provided.

(Supplementary Note 9)

9. The information processing device according to supplementary note 6, wherein

the candidate video data selection means selects the candidate video data from the first video material data by comparing the first score with a first threshold value, and

the reference time determination means selects the reference candidate video data by comparing the first score with a second threshold value stricter than the first threshold.

(Supplementary Note 10)

10. A control method performed by a computer, the control method comprising:

determining a reference time that indicates a time or a time period to be a reference for extracting video data of a second camera different from a first camera, based on candidate video data to be a candidate of a digest of first video material data captured by the first camera;

extracting a further camera shot to be video data of a portion of second video material data captured by the second camera, based on the reference time; and

generating a digest candidate that is a candidate of a digest with respect to the first video material data and the second video material data, based on the candidate video data and the further camera shot.

(Supplementary Note 11)

11. A recording medium storing a program, the program causing a computer to perform a process comprising:

determining a reference time that indicates a time or a time period to be a reference for extracting video data of a second camera different from a first camera, based on candidate video data to be a candidate of a digest of first video material data captured by the first camera;

extracting a further camera shot to be video data of a portion of second video material data captured by the second camera, based on the reference time; and

generating a digest candidate that is a candidate of a digest with respect to the first video material data and the second video material data, based on the candidate video data and the further camera shot.

Although the present invention has been described with reference to the embodiments, the present invention is not limited to the above embodiments. Various changes that can be understood by those skilled in the art can be made to the configuration and details of the present invention within the scope of the present invention. That is, the present invention naturally includes various variations and modifications that a person skilled in the art can make according to the entire disclosure including the scope of claims and technical ideas. In addition, the disclosures of the cited patent documents and the like are incorporated herein by reference.

### DESCRIPTION OF SYMBOLS

1, 1X Information processing device

2 Input device

3 Output device

4 Storage device

6 Learning device

100 Digest candidate selection system

What is claimed is:

1. An information processing device comprising:
a memory storing instructions; and
one or more processors configured to execute the instructions to:
determine a reference time that indicates a time or a time period to be a reference for extracting video data of a second camera different from a first camera, based on candidate video data to be a candidate of a digest of first video material data captured by the first camera;
extract a further camera shot to be video data of a portion of second video material data captured by the second camera, based on the reference time; and
generate a digest candidate that is a candidate of a digest with respect to the first video material data and the second video material data, based on the candidate video data and the further camera shot.

2. The information processing device according to claim 1, wherein, based on the reference time, the processor detects a switching point of the second video material data where a change or a switch regarding a video or sound occurs, and extracts the further camera shot based on the switching point.

3. The information processing device according to claim 2, wherein the processor extracts the further camera shot based on a first switching point of the second video material data searched with reference to a start point of the time period and a second switching point of the second video material data searched with reference to an end point of the time period, in a case where the reference time indicates the time period.

4. The information processing device according to claim 1, wherein the processor extracts, as the further camera shot, video data of the second video material data corresponding to the time period indicated by the reference time.

5. The information processing device according to claim 1, wherein the processor is further configured to select the candidate video data from the first video material data, based on a first score in time series corresponding to the first video material data.

6. The information processing device according to claim 5, wherein the processor selects reference candidate video data which are the candidate video data used to determine the reference time, based on the first score with respect to the candidate video data and a second score different from the first score.

7. The information processing device according to claim 6, wherein
the processor selects the candidate video data based on the first score acquired by inputting segmented video data for each of segments of the first video material data to a first inference engine that is trained to infer the first score with respect to video data being input, and
the processor selects the reference candidate video data based on the second score acquired by inputting the candidate video data with respect to a second inference engine that is trained to infer the second score with respect to the video data being input.

8. The information processing device according to claim 7, wherein
the first inference engine is an inference engine trained based on training video material data to which a label concerning an important segment or not is provided, and
the second inference engine is an inference engine trained based on training video material data to which a label concerning whether a particular event has been occurred is provided.

9. The information processing device according to claim 6, wherein
the processor selects the candidate video data from the first video material data by comparing the first score with a first threshold value, and
the processor selects the reference candidate video data by comparing the first score with a second threshold value stricter than the first threshold.

10. A control method performed by a computer, the control method comprising:
determining a reference time that indicates a time or a time period to be a reference for extracting video data of a second camera different from a first camera, based on candidate video data to be a candidate of a digest of first video material data captured by the first camera;
extracting a further camera shot to be video data of a portion of second video material data captured by the second camera, based on the reference time; and
generating a digest candidate that is a candidate of a digest with respect to the first video material data and the second video material data, based on the candidate video data and the further camera shot.

11. A non-transitory computer-readable recording medium storing a program, the program causing a computer to perform a process comprising:
determining a reference time that indicates a time or a time period to be a reference for extracting video data of a second camera different from a first camera, based on candidate video data to be a candidate of a digest of first video material data captured by the first camera;
extracting a further camera shot to be video data of a portion of second video material data captured by the second camera, based on the reference time; and
generating a digest candidate that is a candidate of a digest with respect to the first video material data and the second video material data, based on the candidate video data and the further camera shot.
